(19) United States
(12) Patent Application Publication
(10) Pub. No.: US 2002/0029193 A1
(43) Pub. Date: Mar. 7, 2002

(54) Method and system for facilitating the transfer of funds utilizing a telephonic identifier

(75) Inventors: Peeyush Ranjan, Sammamish, WA (US); Niraj A. Shah, Issaquah, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: InfoSpace, Inc.

(21) Appl. No.: 09/944,751

(22) Filed: Aug. 31, 2001

Related U.S. Application Data
(60) Provisional application No. 60/229,791, filed on Sep. 1, 2000.

(51) Int. Cl. G06F 17/60

(52) U.S. Cl. 705/39; 705/38

(57) ABSTRACT

A method and system for facilitating the transfer of funds with a telephonic identifier are provided. A payor accesses a funding manager server utilizing a first identifier. The payor funds an account associated with the payor. Contemporaneously or subsequently, the payor designates an amount to transfer to a payee account associated with a second telephone number identifier. If the second telephone number corresponds to an active account in the funding system, the funding system transfers the funds to the payee account and notifies the payee via the telephone number. If the second telephone number does not correspond to an active account, the funding manager server obtains payee information utilizing a reverse look up and creates a payee account associated with the payee telephone number. The funding system transfers the designated funds to the payee account and notifies the payee how to retrieve the funds via the payee telephone number.

### CROSS-REFERENCE(S) TO RELATED APPLICATION(S)

This application claims the benefit of U.S. Provisional Application Ser. No. 60/229,791, filed Sep. 1, 2000, which is hereby incorporated by reference.

### FIELD OF THE INVENTION

In general, the present invention relates to electronic commerce and in particular, to a method and system for facilitating the transfer of funds between parties utilizing telephonic identifiers.

### BACKGROUND OF THE INVENTION

The widespread increase in electronic commerce creates the need for services that facilitate monetary transactions between two parties. Generally described, global communication networks, such as the Internet, allow users from distant geographic areas to readily communicate and transact business without ever physically associating with one another. For example, there are currently on-line auction services that allow any number of Internet users to bid and pay for merchandise offered by another user. In such an application, the payor and payee can be remote from one another. Additionally, the two parties may not know each other beyond the information required to participate in the Internet on-line auction, such as names, alias, or other identifiers. Because the parties do not know one another, the payee requires assurances that funds are available and will be transferred upon completion of the transaction. Additionally, the purchaser requires assurances that no funds will be transferred until the goods/services are found to be acceptable. Thus, the transferring of value between the parties can become involved.

The payor/payee requirements can also extend to non-Internet related transactions. For example, users may communicate and transact business via mobile devices, such as wireless telephones, which may in some cases be used even when the payor and the payee are not in close proximity. Similar to an Internet transaction where parties are physically remote from one another, they may not know each other beyond a respective telephone number. Accordingly, the parties require assurances to transact business. Alternatively, the parties may be in close proximity, but do not have an efficient and reliable method for transferring funds.

One system for transacting business involves the parties utilizing traditional funding sources, such as currency or credit cards. However, the parties may not have access to or wish to use these typical funding sources. For example, currency is readily subject to theft and, in international transactions, may require exchange between national forms. Credit card transactions may not be possible because the payor may not have a credit card, the payee may not have the capability to process a credit card transaction, and/or credit card transactions may not be desirable because of fees associated with processing transactions. When the payor and payee are remote from each other, the distribution of credit information and/or currency raises particular security and privacy issues that negate the ease of the transaction. Additionally, these traditional funding sources do not provide assurances to either party that the transaction can be completed without the other party breaching the scope of the agreement.

Another system for transferring funds between two parties establishes an Internet-based intermediary that utilizes e-mail accounts and e-mail correspondence. In such a system, the payor accesses an account provided by an Internet-based intermediary. The payor funds the account, such as through an ACH bank transfer or a credit card authorization, and instructs the Internet-based intermediary to credit a specific amount to an e-mail account corresponding to a payee. Funds are deposited in the payee account and the payee is notified of the funding via an e-mail notification.

Although this Internet based funds transferring system allows two parties to complete Internet-based actions, the applicability of the system is limited in that both parties must have access to e-mail accounts. Additionally, even if each party can be identified by a specific e-mail account, the e-mail address may be difficult to remember or communicate. Moreover, some e-mail accounts, such as a work e-mail account, may prohibit personal uses. Still further, by its nature, Internet-based funds transferring systems are typically limited to computer-facilitated transactions, and would not facilitate non-Internet based commerce.

Accordingly, there is a need for a system and method that facilitates the transfer of funds between two parties utilizing identifiers more easily applicable to various types of commerce.

### SUMMARY OF THE INVENTION

A method and system for facilitating the transfer of funds with telephonic identifiers are provided to overcome the deficiencies in the prior art. In accordance with aspects of the present invention, a method for facilitating the processing of a transaction including the transfer of value between a first and a second user, where the second user is associated with a telephonic identifier, is provided. A transfer server is in communication with various telephonic devices, such as mobile or wireline devices, utilized by the first and second users to transact in commerce. The transfer server obtains a request from the first user to transfer a quantity of value to the second user, wherein the request includes the telephonic identifier associated with the second user. The transfer server accesses an account corresponding to the first user, and transfers the quantity of value from the account corresponding to the first user to an account corresponding to the telephonic identifier associated with the second user.

In accordance with another aspect of the present invention, a system for facilitating the process of a transaction including the transfer of value between a first and a second user is provided, wherein the second user associated with a telephonic identifier. The system includes a first user desiring to transfer a quantity of value from a first user account, and a second user for receiving the quantity of value. The system establishes an account associated with the telephonic identifier of the second user. The system further includes a transfer server operable to receive a request from the first user desiring to transfer the quantity of value from the first user account, the request including the telephonic identifier of the second user. The transfer server is further operable to transfer the quantity of value to the account associated with the second user.

In accordance with yet another aspect of the present invention, a computer readable medium having computer-executable components for facilitating the process of a transaction including the transfer of value between a first and a second user is provided, wherein the second user associated with a telephonic identifier. The computer readable medium includes a carrier interface component operable to interface with one or more telephone service carriers, the service carrier in communication with the first user. The computer readable medium also includes an user account component operable to receive a request from the first user to transfer a quantity of value from an account associated with an identifier of the first user, the request including the telephonic identifier associated with the second user. The user account component is further operable to access the account associated with the identifier of the first user. The user account component is still further operable to determine whether an account is associated with the telephonic identifier of the second user, and process the transfer of value between the account of the first user and the account of the second user if the second user telephonic identifier corresponds to an account.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a representative portion of the Internet;

FIG. 2 is a block diagram of a funding system for transferring funds between a payor and a payee in accordance with the present invention;

FIG. 3 is a block diagram depicting an illustrative architecture for a mobile device utilized in accordance with the present invention;

FIG. 4 is a block diagram illustrative of a mobile device communication configuration utilized to communicate with the funding system in accordance with the present invention;

FIG. 5 is a block diagram depicting an illustrative architecture for a funding manager server in accordance with the present invention;

FIG. 6 is a flow diagram of a fund transfer routine executed by a funding manager server in accordance with the present invention;

FIG. 7 is a block diagram of a funding system for transferring funds between a payor and a payee utilizing third-party account managers in accordance with the present invention; and

FIG. 8 is a flow diagram of a fund transfer routine utilizing third-party account managers executed by a funding manager server in accordance with the present invention.

### DETAILED DESCRIPTION OF THE PREFERRED EMBODIMENT

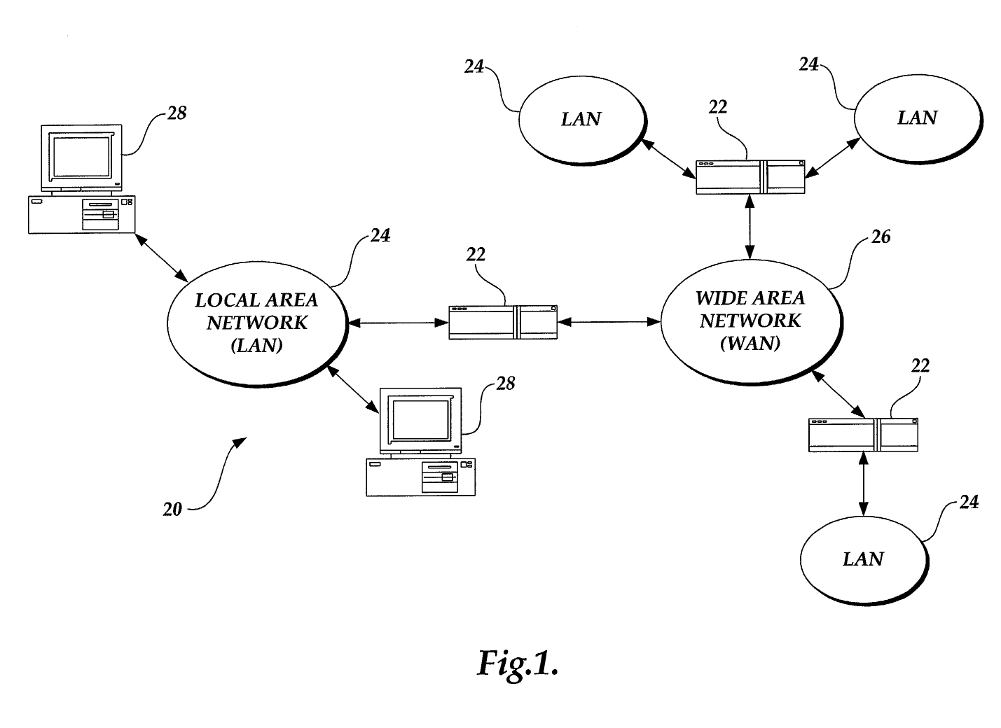

It will be appreciated by one skilled in the relevant art that aspects of the present invention may be embodied in a World Wide Web (the “WWW” or “web”) site accessible via the Internet. As is well known to those skilled in the art, the term “Internet” refers to the collection of networks and routers that use the Transmission Control Protocol/Internet Protocol (“TCP/IP”) to communicate with one another. A representative section of the Internet 20 is shown in FIG. 1, in which a plurality of local area networks (“LANs”) 24 and a wide area network (“WAN”) 26 are interconnected by routers 22. The routers 22 are special purpose computers used to interface one LAN or WAN to another. Comnmunication links within the LANs may be twisted wire pair, or coaxial cable, while communication links between networks may utilize 56 Kbps analog telephone lines, 1 Mbps digital T-1 lines, 45 Mbps T-3 lines or other communications links known to those skilled in the art. Furthermore, computers and other related electronic devices can be remotely connected to either the LANs 24 or the WAN 26 via a modem and temporary telephone or wireless link. It will be appreciated that the Internet 20 comprises a vast number of such interconnected networks, computers, and routers and that only a small, representative section of the Internet 20 is shown in FIG. 1.

The Internet has recently seen explosive growth by virtue of its ability to link computers located throughout the world. As the Internet has grown, so has the WWW. As is appreciated by those skilled in the art, the WWW is a vast collection of interconnected or “hypertext” documents written in HyperText Markup Language (“HTML”), or other markup languages, that are electronically stored at “WWW sites” or “Web sites” throughout the Internet. Other interactive hypertext environments may include proprietary environments such as those provided by America Online or other on-line service providers, as well as the “wireless web” provided by various wireless networking providers. One skilled in the relevant art will appreciate that the present invention can be implemented in any such interactive hypertext environments.

A WWW site is a server/computer connected to the Internet that has mass storage facilities for storing hypertext documents and that runs administrative software for handling requests for those stored hypertext documents. Embedded within a hypertext document are a number of hyperlinks, i.e., highlighted portions of text which link the document to another hypertext document possibly stored at a WWW site elsewhere on the Internet. Each hyperlink is associated with a Uniform Resource Locator (“URL”) that provides the exact location of the linked document on a server connected to the Internet and describes the document. Thus, whenever a hypertext document is retrieved from any WWW server, the document is considered to be retrieved from the WWW. As is known to those skilled in the art, a WWW server may also include facilities for storing and transmitting application programs, such as application programs written in the JAVA® programming language from Sun Microsystems, for execution on a remote computer. Likewise, a WWW server may also include facilities for executing scripts and other application programs on the WWW server itself.

A consumer or other remote consumer may retrieve hypertext documents from the WWW via a WWW browser application program. A WWW browser, such as Netscape's NAVIGATOR® or Microsoft's Internet Explorer, is a software application program for providing a graphical consumer interface to the WWW. Upon request from the consumer via the WWW browser, the WWW browser accesses and retrieves the desired hypertext document from the appropriate WWW server using the URL for the document and a protocol known as HyperText Transfer Protocol (“HTTP”) . HTTP is a higher-level protocol than TCP/IP and is designed specifically for the requirements of the WWW. HTTP runs on top of TCP/IP to transfer hypertext documents between server and client computers. The WWW browser may also retrieve application programs from the WWW server, such as JAVA applets, for execution on the client computer.

A consumer or other remote consumer may communicate via the Internet through a simple mail transfer protocol (“SMTP”) . As is well understood, SMTP is a protocol utilized by a message transport system to transfer electronic mail (“e-mail”) between two computers. Moreover, additional or alternative electronic mail protocols may be practiced by the present invention.

One skilled in the relevant art will further appreciate that aspects of the present invention may be utilized with mobile communication devices. Mobile devices, such as telephones and pagers, can receive wireless transmission containing textual messages for display. The wireless data is transmitted via UHF or VHF frequency bands to be received by a selected mobile device. In one embodiment, the mobile devices may also utilize the wireless transmission of short text messages, commonly referred to as short message service (“SMS”) . SMS involves the wireless transmission of textual messages that conform to a protocol. Specifically, the SMS protocol limits the maximum length of the textual message by truncating textual data after the maximum data size has been achieved. In practice, a short message service center (“SMSC”) obtains SMS data to transmit to a mobile device. The SMSC determines the device's capabilities and whether it is available to receive the SMS data. The SMSC may utilize its own status database or may alternatively utilize external data processing such as a global title translation. Upon locating the device, the SMS data is transmitted to the mobile device via a wireless frequency ban. Additionally, if the mobile device is unavailable, the SMSC may queue the SMS data for a set period and attempt to retransmit the SMS data. It will be appreciated that the present invention may be practiced with alternative text messaging configurations and that specific SMS text messaging configurations may involve additional protocols and components.

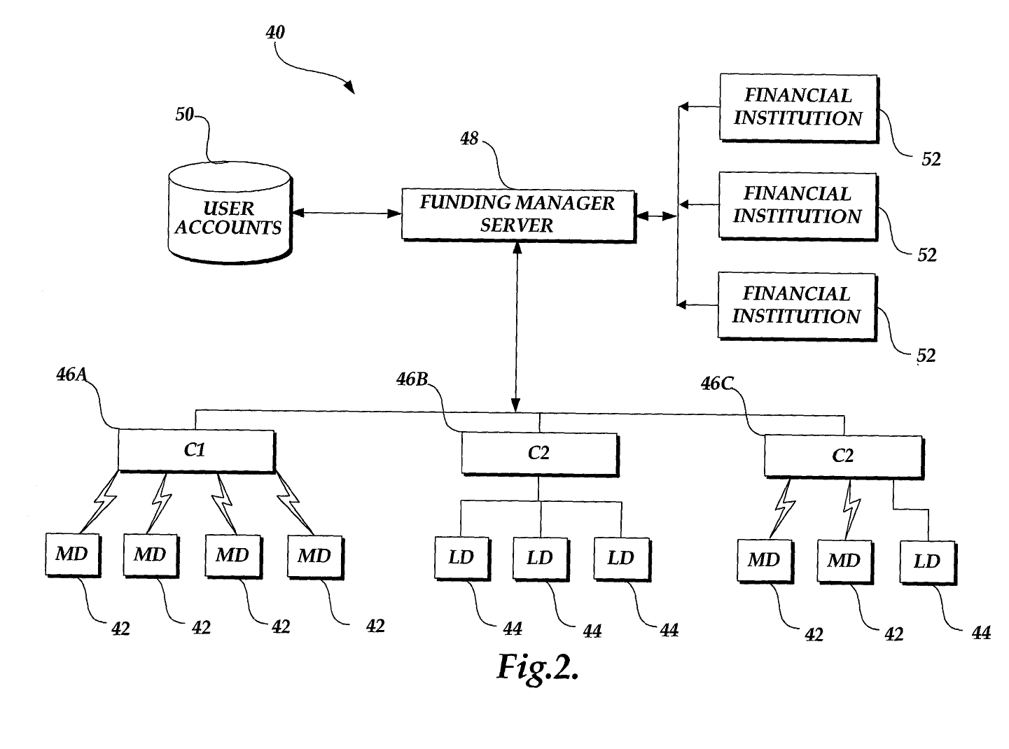

Referring now to FIG. 2, an actual embodiment of the present invention will be described. FIG. 2 is a block diagram illustrative of a funds transfer system 40 for transferring funds between a payor and a payee in accordance with the present invention. The system 40 includes a variety of telephonic devices, which can include mobile communication devices, such as mobile devices 42, wireline communication devices 44, and combinations thereof. In an illustrated embodiment, each telephonic user is associated with a unique telephone number, such as a tendigit telephone number.

Connected to the telephonic devices, by wired or wireless communication mediums, are a variety of telephonic carriers 46. Generally described, the telephonic carriers offer the telephonic services to the user. As illustrated in FIG. 2, the carriers 46 may be both dedicated mobile device carriers 46A, dedicated wireline device carriers 46B or combination mobile device/wireline device carriers 46C.

Each carrier 46A, 46B, or 46C is in communication with a funding manager server 48 that facilitates the transfer of funds. The carriers 46A-46C may communicate via a dedicated or semi-dedicated communication line or they may communicate via a WAN, such as the Internet. The funding manager server 48 has access to a user accounts database 50 for storing user account information. The user accounts database 50 may be a locally stored and managed database, or alternatively, may include remote data management. Additionally, the user accounts database 50 may also be managed by third parties that may specialize in account and user funds management.

Still referring to FIG. 2, also in communication with the funding manager server 48 may be a variety of financial institutions 50, such as banks or credit card companies that facilitate the initial or subsequent transfer of funds from the user to the funds transfer system 40. Additionally, the financial institutions may also facilitate the crediting of a payor account. In an illustrative embodiment of the present invention, and as will be explained in greater detail below, the communication carrier 46A-46C may also serve the function of the financial institution.

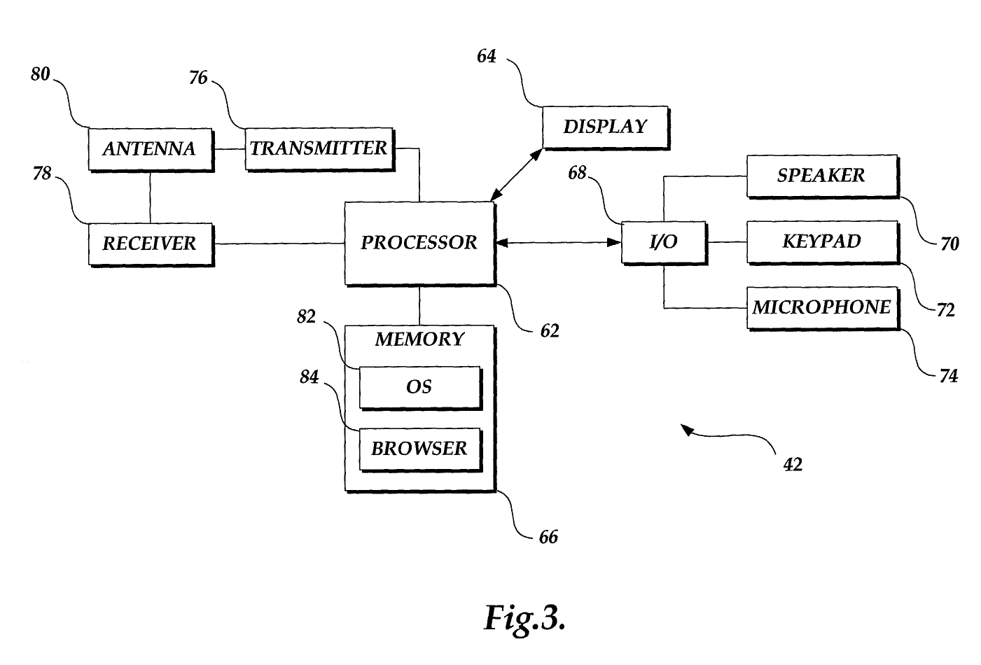

FIG. 3 is a block diagram of an illustrative architecture for a mobile device 42. As shown in FIG. 3, the mobile device 42 includes a processor 62, a display 64 and a memory 66. The display 64 may include any variety of display devices including, but not limited to a liquid crystal display, a color display, and/or a light emitting diode display. Also connected to the processor is an input/output interface 68, which connects to a speaker 70, a keypad 72 and a microphone 74. As would be readily understood by one skilled in the relevant art, alternative input/output configurations are considered to be within the scope of the present invention. The mobile device 60 also includes a transmitter 76 and receiver 78, which are connected to an antenna 80 for sending and receiving wireless communications respectively. The mobile device 60 may also include a modulator and demodulator for formatting data transmissions according to an air interface standard. It should be understood that the mobile device may be capable of operating with one or more air interface standards, modulation types and data accessing types without departing from the scope of the invention.

The memory 66 generally comprises a random access memory (“RAM”), a read-only memory (“ROM”) and may also include a permanent mass storage device, such as a hard disk drive, tape drive, optical drive, floppy disk drive, CD-ROM, DVD-ROM or removable storage drive. The memory 66 stores an operating system 82 for controlling operation of the mobile device. In applications using HTTP, the memory also includes a WWW browser 84 for accessing the WWW. The browser 84 may be specially configured to receive, display and transmit data from a mobile device, such as wireless markup language (WML)-compliant application. In applications using other protocols, as with SMS-enabled devices, the device memory is configured to receive, display and transmit data in such other protocols. As would be readily understood, the memory 66 may contain additional applications for accessing multiple networks. It will be appreciated that these components may be stored on various computer-readable mediums and loaded into memory using a drive medium associated with the computer-readable medium. Moreover, it will be readily understood by one skilled in the relevant art that the present invention additionally is compatible with legacy mobile devices that have only telephonic communication available.

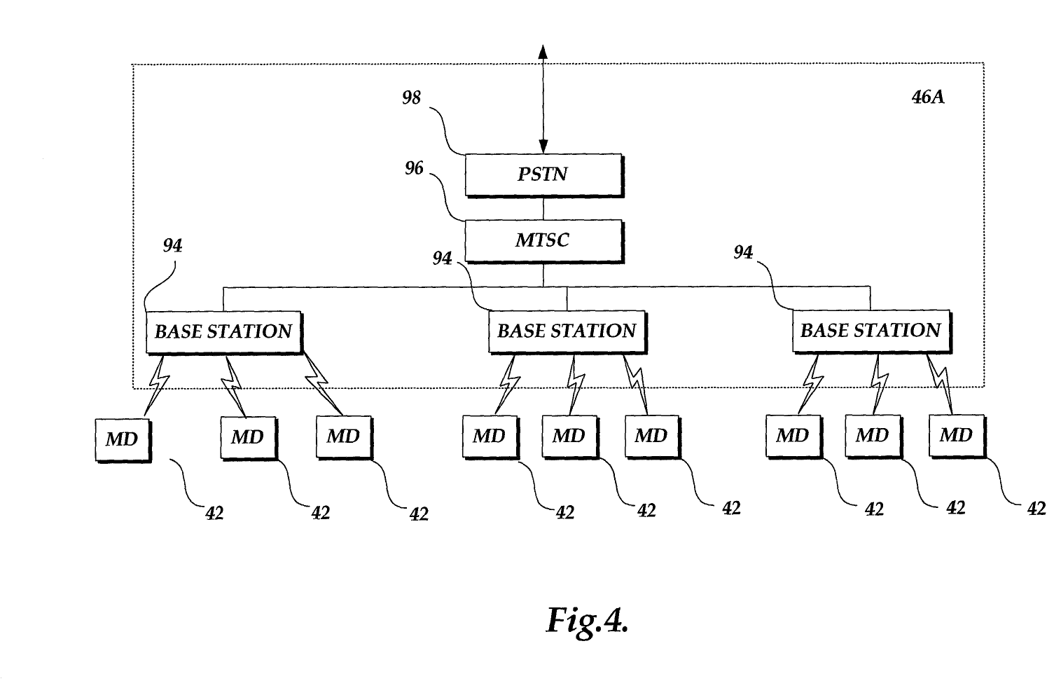

FIG. 4 is a block diagram illustrative of a mobile device telephonic communication 90 configuration provided by a mobile device carrier 46A in accordance with the present invention. Each mobile device 42 communicates with one or more base stations 94, such as a cellular base station, which include a transceiver and a controller for transmitting and receiving wireless communication data from the mobile device. In turn, the base stations 94 are in communication with a mobile telephone switching center 96 (“MTSC”) . The MTSC is known to those skilled in the relevant art as a digital telephone exchange that controls switching between the base stations 94 and a public switched telephone network 98 (“PSTN”) for all wireline-to-mobile, mobile-to-wireline and mobile-to-mobile calls. Data can then be transferred to the funding manager server 48 via a communications network, such as a telephone line via the Internet 20. As will be readily understood by one skilled in the relevant art, the processing of wireless communication may entail additional or alternative components and/or steps. Accordingly, the system disclosed in FIG. 4 is intended solely for illustrative purposes and will not be described in any greater detail.

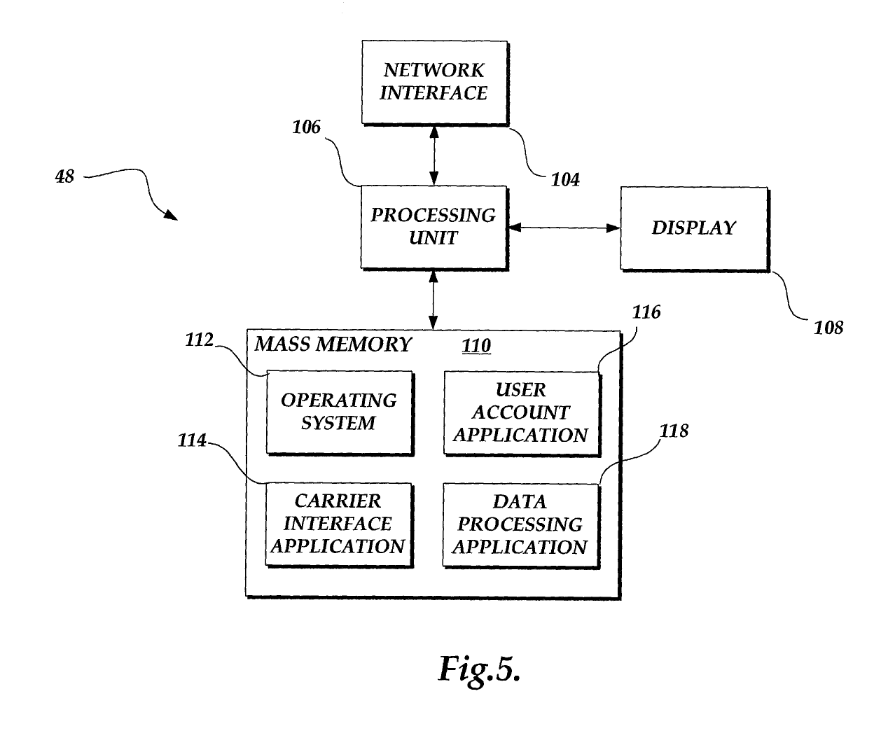

FIG. 5 is a block diagram depicting an illustrative architecture for a funding manager server 48. Those of ordinary skill in the art will appreciate that the funding manager server 48 includes many more components then those shown in FIG. 5. However, it is not necessary that all of these generally conventional components be shown in order to disclose an illustrative embodiment for practicing the present invention. As showing in FIG. 5, the funding manager server 48 is connected to the Internet via a network interface 104. Those of ordinary skill in the art will appreciate that the network interface 104 includes the necessary circuitry for connecting to the Internet and is constructed for use with various communication protocols, such as TCP/IP protocol, the Internet Inter-ORB Protocol (“IIOP”), and the like.

The funding manager server 48 also includes a processing unit 106, a display 108 and a mass memory 110, all connected via a communication bus, or other communication device. The mass memory generally comprises a RAM, ROM, and a permanent mass storage device, such as a hard disk drive, tape drive, optical drive, floppy disk drive, or combination thereof. The mass memory 110 stores an operating system 112 for controlling the operation of the funding manager server. It will appreciated that this component may comprise a general-purpose server operating system as is known to those skilled in the art, such as UNIX, LINUX™, or Microsoft WINDOWS NT®.

The mass memory 110 also stores program code and data for interfacing with the telephone service carriers, for processing the user accounts and for processing the fund transfer requests. More specifically, the mass memory 110 stores a carrier interface application component 114 in accordance with the present invention for interfacing with the user through the telephone carrier service. The carrier interface application 114 comprises computer-executable instructions which, when executed by the funding manager server 48, transmits and receives consumer data as will be explained below in greater detail.

The mass memory 110 also stores a user account application component 116 for obtaining funding requests, processing fund transfers and processing withdrawals for funded accounts. The operation of the user account application component 116 will be described in greater detail below. The mass memory 110 further stores a data processing application component 118 for associating a telephone identifier with additional information in accordance with the funding process of the present invention. The operation of the data processing application component 118 will be described in greater detail below. It will be appreciated that these components may be stored on a computer-readable medium and loaded into the memory of the funding manager server using a drive mechanism associated with the computer-readable medium, such as a floppy, CD-ROM, DVD-ROM drive, or network interface 104.

In general, the present invention allows a payor associated with a first telephone-based account to fund an account and, contemporaneously or subsequently, designate a specific amount of value to transfer to a second telephone-based account associated with a payee. While the illustrative embodiments described and illustrated herein have referred to the term “funds” with a connotation of money, i.e. cash, currency, credit, commercial paper, it will be readily evident that any transfer of value may be facilitated by the present invention. For example, value may include, but is not limited to, coupons, rebates, vouchers, points or miles awarded by a particular vendor, or any other tangible or intangible property, good, or service. If the payee has an account with the funding manager server 48 (FIG. 2), the funds are transferred and the payee is notified via the telephone number. If the payee does not have a current account, a payee account is created, the funds are transferred to the account and the payee is instructed how to retrieve the funds via the telephone number.

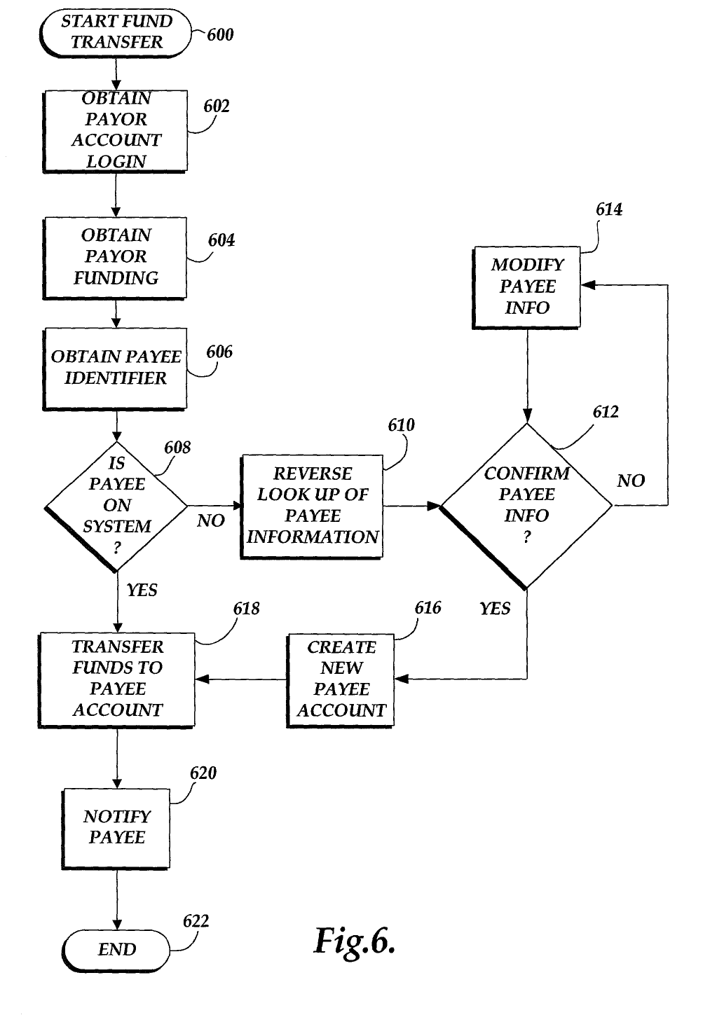

FIG. 6 is a flow diagram illustrative of a fund transfer routine 600 implemented by the funding manager server 48 to facilitate the transfer of funds from a payor to a payee in accordance with the present invention. At block 602, the user account application 116 of the funding manager server 48 obtains a payor account login. Generally, the payor account login may take several forms, dependent on the amount of security provided by the fund transfer system 40. One skilled in the relevant art will appreciate that a mobile device carrier 46A assigns mobile telephone devices 42 a unique identifier to provide the mobile telephone service. Accordingly, in one illustrative embodiment, the funding manager server utilizes the mobile device identifier to identify the payor. In another embodiment, the login identifier may take the form of a telephone number associated with the payor which can be automatically retrieved from the wireline or wireless telephone used to make the connection by utilizing a caller identification function. Alternatively, the payor may have an opportunity to enter a specific telephone number by utilizing a menu login. For additional security, the payor may also be prompted to enter a personal identification number (“PIN”) . Alternatively, other security measures such as voice recognition, smart cards, or biometric sensors, may be utilized to identify a particular payor.

At block 604, the user account application 116 of the funding manager server 48 obtains a funding of the payor account. Generally, the funding of an account can be accomplished in a variety of manners. For example, the payor may authorize a funds transfer from the financial institution 50 such as a bank. Alternatively, the payor may authorize a credit transfer from a credit card company, or submit a cash payment or wire transfer to a service associated with the funding manager server 48. One skilled in the art will appreciate that a carrier or service associated with the funding manager server 48 may also extend the payor a line of credit from which to authorize for funding of the account. For example, a carrier, such as a mobile device carrier 46A or wireline carrier 46B, may incorporate fund transfers as part of the standard service charges delivered to the payor. Additionally, the payor may also maintain a balance in a payor account and thereby omit the block 604 if there are sufficient funds in the account.

At block 606, the user account application 116 obtains a designation of a payee from the payor in the form of a telephone number. In an illustrative embodiment, the payor inputs a ten-digit telephone number for identifying the account. The telephone number can be directly associated with the payee, i.e. the payee's actual telephone number being the account number. It will be appreciated by one skilled in the relevant art that the payor may enter the telephone number via a standard keypad, by speaking the number into the telephone, or by having the telephone number programmed into a telephone. In the event more than one user corresponds to a payee telephone number, the payor may indicate a specific subaccount that corresponds to the payee.

In an alternative embodiment, the telephone number inputted may be a proxy telephone number that is associated with the payee. For example, the payor can enter a ten digit proxy number, 111-222-3333, which is then associated by the funding manager server 48 to a payee. This can be beneficial in the case where a payee has an unlisted number that he/she wishes not to divulge. In this case, the payee can give a proxy number to the payor that the funding manager server 48 associates with the unlisted number of the payee or directly with a payee account. An illustrative example of a system for routing communications utilizing proxy identifiers that could be utilized for routing proxy telephone numbers can be found in commonly assigned U.S. Pat. No. 6,230,188 to Marcus, which is hereby incorporated by reference.

At decision block 608, a test is done to determine whether the payee telephone number corresponds to an active funding account with the funds transfer system 40. If the telephone number corresponds to an active account, the process 600 continues to block 618, as will be explained below. However, if the telephone number does not correspond to an active account at decision block 608, the data processing application 118 of the funding manager server 48 performs a reverse lookup of the payee telephone number at block 610.

In an illustrative embodiment, the funding manager server 48 may maintain a database having user information corresponding to at least a portion of the available ten-digit telephone numbers. The database may be limited by geographic region, and/or by specific carrier. Alternatively, the funding manger server 48 may utilize one or more third party services to identify a party associated with the payee telephone number. Still further, the funding manager server 48 may utilize two or more methods of searching for a party identifier from a telephone number to mitigate errant information.

At decision block 612, a test is done to determine whether the information found in the reverse look up corresponds to the payee designated by the payor. Depending on the type of communication device and/or communication network being utilized by the payor, the funding manager server 48 may send a visual display listing the proposed payee information to a telephone having display capabilities. Alternatively, the information may be presented to the payor in an audio format. The information display may be conducted automatically by the user interface application 116 of the funding manager server 48, or alternatively, a live operator may interact with the payor to transmit the information.

If the payor indicates that the reverse look up information is not correct, at block 614, the payor may amend the information or enter in the appropriate information via a variety of inputting methods, such as voice input, keypad entry, and the like. Accordingly, decision block 612 and block 614 is repeated until the payee information is confirmed. Once the payee information is confirmed, at block 616, a new account is established for the payee according to the information received from the payor and/or the reverse look up. In an illustrative embodiment, the payee account may be a permanent account that may be utilized after the termination of the fund transfer. Alternatively, the payee account may be a temporary account that expires upon the completion of the present transaction.

If the payee identifier corresponds to a current account at decision block 608 or once a new payee account has been opened at block 616, at block 618, the funds designated by the payor are transferred to the payee account. In one embodiment, the user account application 116 causes funds be to transferred to the payee account based on certain criteria selected by the payor. In this embodiment, once the criteria is satisfied, the funds are released from the payor account and transferred to the payee account. For example, the payor may want to have the transfer occur on a specific date. Accordingly, once the date specified is reached, the funds are automatically transferred to the payee account. Other criteria may include, but is not limited to, on the occurrence of an event. For example, the funds may be released from the payor account and transferred to the payee account as soon as the payor makes funds available to the payor account or that the payor has received the goods or the services from the payee. In each embodiment, the criteria is set by the payor and may be entered into the funding system when the payor is requesting a funds transfer.

At block 620, the carrier interface application 114 notifies the payee of the transfer of funds. The notification of the transfer of funds to the payee may depend on the whether the payee has an active account. If the payee has an active account, the notification may be specified by the payee, such as a telephone call to a number associated with the payee. Alternatively, the payee may be notified by a SMS message to the payee device, a SMS or numerical page to a pager associated with the payee, or an e-mail to an address associated with the payee. However, if the payee did not have a previous current account, the notification of the transfer of funds begins with a telephone call (including a voice and/or SMS message), which includes instructions for how the payee can log into the payee account and retrieve the funds. The payor may also be notified of a successful fund transfer by an immediate message via voice, HTTP, SMS, SMTP, etc.

In an illustrative embodiment, the funding manager server 48 may generate a generic notification message for each funding account. The generic message may be routed through a multi-protocol exchange that can translate the notification message into an appropriate format for the recipient. Accordingly, the funding manager server48 would not be required to support various messaging formats. The routine 600 then terminates at block 622.

It will be appreciated by one skilled in the relevant art that the payee may be notified of a proposed fund transfer, such as through a SMS message, prior to the transfer to confirm that the payor has made appropriate funds available. Additionally, the payor may be given an additional opportunity to wait to approve the transfer of the funds until the receipt of the goods or the performance of the service by the payee.

In an illustrative embodiment of the present invention, a transaction record documenting a party's fund transfers can be provided to the payor/payee on a periodic basis. For example, a telephone service carrier may provide a listing of a payor/payee's transactions as part of their standard billing statement. The transaction record may include an itemization listing telephone number accounts and the respective amount transferred to or from each account. Additionally, in the event the telephone service carrier provides credit to facilitate the transfer, the transaction record may reflect an amount owed by the payor. Moreover, the transaction record may also serve to notify a payee/payor that a transfer has been completed.

Other embodiments are contemplated by the inventors to be within the scope of the present invention including criteria or instructions established by the payee. For example, the payee can authorize the funds transfer system to transfer the funds to a third-party once the funds are received from the payor. In this example, the payee becomes a new payor having specific criteria satisfied, i.e. once sufficient funds are deposited from specific payor then pay third party, whereby the third party becomes the new payee.

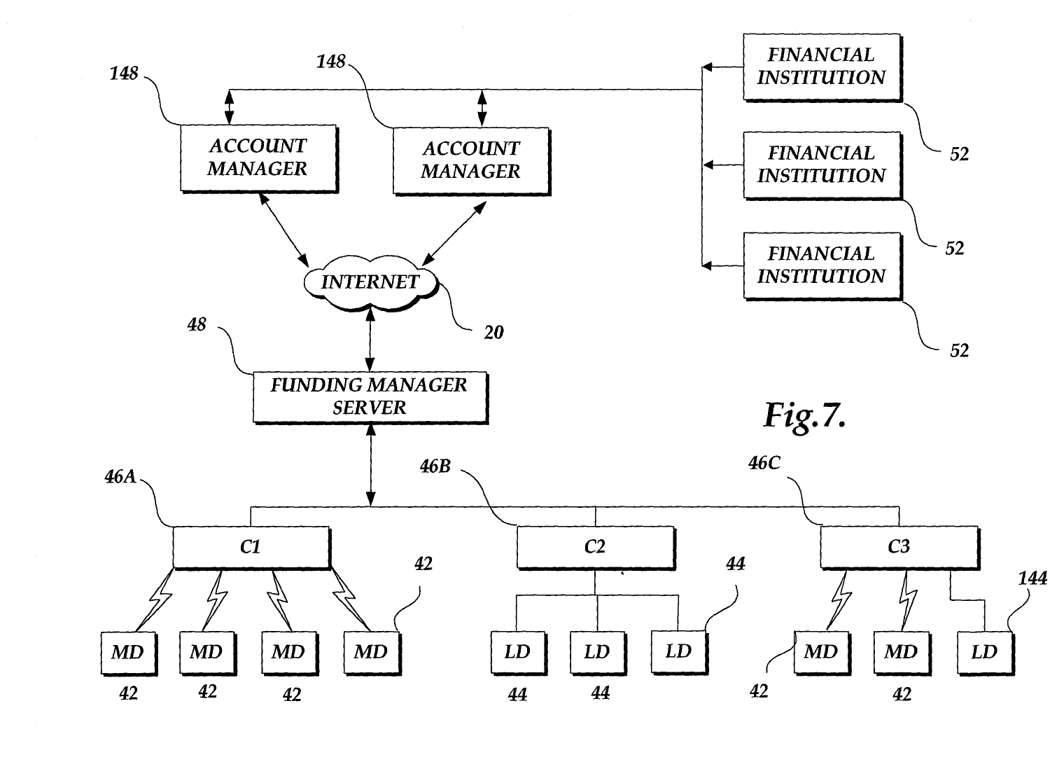

In an alternate embodiment of the present invention, the funding system can included one or more third party services for managing value to be transferred. FIG. 7 is a block diagram illustrative of a funds transfer system 140 utilizing third party account managers to facilitate the transfer of funds between a payor and a payee in accordance with the present invention. The alternative funds transfer system 140 is similar to the funds transfer system 40 illustrated in FIG. 2 in that various mobile and wireline users 42 and 44 are connected to a funding manager server 48 via a telephone carrier 46A, 46B, and 46C. However, in this alternative funding system, the funding manager server 48 does not include a user accounts database or various interfaces with financial institutions. Instead, the funding manager server 48 utilizes one or more third-party account managers 148 to conduct the actual fund transfers and to receiver/transfer funds with various financial institutions 52.

In an illustrative embodiment of the present invention, the funding manager server 48 utilizes the network interface 104 to connect to various account managers 148 via the Internet 20. The account managers 148 obtain the initial or subsequent fund transfers from the payor, transfer the funds between a payor account and a payee account according to direction by the funding manager server and deliver the funds to the payee once the transfer is complete. Although this alternative embodiment will be described in terms of an Internet-based third-party accounting system, this embodiment is disclosed for illustrative purposes and should not be read as limiting to the present invention. Moreover, one skilled in the relevant art will appreciated that the funding manager server 48 may retain some account functionality

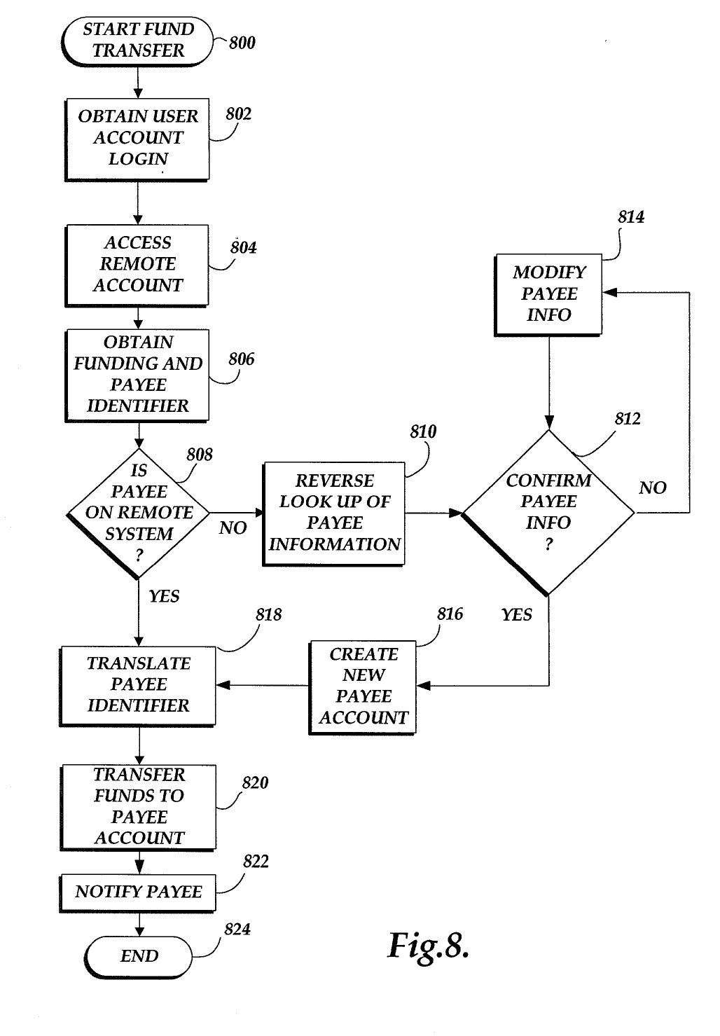

FIG. 8 is a flow diagram illustrative of a fund transfer routine 800 executed by the funding manager server 48 for a funding system utilizing third-party account managers 148 (FIG. 7). At block 802, the carrier interface application 114 of the funding manager server 48 obtains a payor user account login. As described above with respect to block 602 (FIG. 6), the payor account login may take several forms, dependent on the amount of security provided by the funds transfer system 140 (FIG. 7) and the capabilities of the device utilized by the payor to access the system. At block 804, the funding manager server 146 (FIG. 7) accesses the remote account. In the illustrative embodiment of the present invention, the account manager 148 is an Internet-based service that utilizes e-mail addresses to identify user accounts. To accomplish the login function, the data processing application 118 of the funding manager server 48 translates the payor's phone number identification into a e-mail address that corresponds to the payor's account on the third-party account manager. Accordingly, the payor does not need to identify himself or herself with an e-mail account.

Once the user account application 116 of the funding manager server 48 payor has accessed the account, at block 806, the payor may make funds available into the account. As described above with respect to block 604 (FIG. 6), the transfer of funds to an account can be accomplished in a variety of manners. However, in the alternative embodiment, the third-party account managers 148 manage at least some portion of the transfer of the funds from the financial institutions 52 without additional interaction by the funding manager server 48.

At block 806, the carrier interface application 114 obtains a designation of a payee from the payor in the form of a telephone number. In an illustrative embodiment, the payor inputs a ten-digit telephone number for identifying the account. As disclosed above with reference to block 606 (FIG. 6), the telephone number can be an actual or proxy telephone number. At decision block 808, a test is done to determine whether the payee telephone number corresponds to an active funding account with the funding system. If the telephone number corresponds to an active account, the process 800 continues to block 818, as will be explained below. However, if the telephone number does not correspond to an active account at decision block 808, the funding manager server 48 performs a reverse lookup of the payee telephone number at block 810.

As described above with respect to block 610 (FIG. 6), the funding manager server 48 may maintain a database having information corresponding to various ten-digit telephone numbers for a geographic region or for a specific carrier. Alternatively, the funding manger server 48 may utilize one or more third party services to identify a party associated with the payee telephone number. Additionally, the funding manager server 48 may utilize two or more methods of searching for information corresponding to a telephone number to confirm a payee identification.

At decision block 812, a test is done to determine whether the information found in the reverse look up corresponds to the payee the payor has identified. If the payor indicates that the reverse look up information is not correct, at block 814, the payor may amend the information or enter in the appropriate information via a variety of inputting methods, such as voice recognition or keypad entry. Once the payee information is confirmed, at block 816 a new account is established for the payee according to the information received from the payor and the reverse look up.

If the payee identifier corresponds to a current account at decision block 808 or once a new payee account has been opened at block 816, at block 818, the payee account telephone identifier is translated to correspond to a third-party account identifier. In the illustrative embodiment, the data processing application 118 translates the payee telephone identifier to the e-mail identifier by accessing a database of pre-stored account identifiers or by utilizing a standard naming algorithm to generate a new e-mail identifier for new accounts. As would be readily understood, the transaction is based on the identification requirements, if any, of the third party account manager.

At block 820, the funds designated by the payor are transferred to the payee account and at block 822, the payee is notified of the transfer of funds. As discussed above with respect to block 618 (FIG. 6), the transfer may be based on the completion of certain criteria selected by the payor such as being date specific or the occurrence of an event. Additionally, as discussed above with respect to block 620 (FIG. 6), the notification of the transfer of funds to the payee may include various methods and forms. The routine 800 then terminates at block 824.

The present application is directed to a system that facilitates the transfer of funds between parties utilizing a telephonic identifier. Telephonic identifiers generally correspond to a larger portion of the population. Additionally, telephonic identifiers facilitate the utilization of mobile telephones, whose use is increasing. Additionally, telephonic identifiers allow communication carriers to incorporate the funds transfer feature of the present invention into standard service features.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for facilitating the processing of a transaction including the transfer of value between a first and a second user, said second user associated with a telephonic identifier, comprising:
obtaining a request from said first user to transfer a quantity of value to said second user, wherein said request includes said telephonic identifier associated with said second user;
accessing an account corresponding to said first user; and
transferring said quantity of value from said account corresponding to said first user to an account corresponding to said telephonic identifier associated with said second user.

2. The method of claim 1 further comprising obtaining a request for funding said first user account with said quantity of value to enable the transfer of said quantity of value.

3. The method of claim 2, wherein said quantity of value includes a monetary amount.

4. The method of claim 2, wherein said quantity of value includes a line of credit.

5. The method of claim 1, wherein if said telephonic identifier associated with said second user does not correspond to an account, creating an account based on said telephonic identifier of said second user.

6. The method of claim 1 further comprising notifying said second user of the transfer of said quantity of value.

7. The method of claim 6, wherein said second user is notified of the transfer via a group of notification means associated with said telephonic identifier of said second user consisting essentially of a telephone call notification, a short messaging service notification, an electronic mail notification, and a pager notification.

8. The method of claim 7, wherein said second user is notified by said notification means preselected by said second user.

9. The method of claim 1 further comprising notifying said first user of the transfer of said quantity of value.

10. The method of claim 1, wherein accessing an account includes accessing a remote account corresponding to said first user.

11. The method of claim 1, wherein accessing an account includes accessing a remote account associated with said telephonic identifier of said second user.

12. The method of claim 1, wherein said telephonic identifier of said second user is a proxy telephonic identifier.

13. The method of claim 1, wherein said quantity of value is one of a group consisting essentially of coupons, vouchers, point, rebates, services, monetary funds, credits, and personal goods.

14. The method of claim 1, wherein said request includes criteria that must be satisfied prior to the transfer of value.

15. The method of claim 14, wherein said criteria is date specific.

16. The method of claim 14, wherein said criteria is based on an occurrence of an event.

17. The method of claim 1, wherein said first user is associated with an identifier, said identifier of said first user being associated with a wireless telephone or a wireline telephone.

18. The method of claim 1, wherein the transfer between said accounts occurs via a communication to a service provider, said service provider transferring said value between said accounts.

19. A computer readable medium having computer-executable instructions for performing the method recited in any one of claims 1-18.

20. A computer system having a processor, a memory, and an operating environment, said computer system operable to perform the method recited in any one of claims 1-18.

21. A computer readable medium having computer-executable components for facilitating the process of a transaction including the transfer of value between a first and a second user, said second user associated with a telephonic identifier, comprising:
a carrier interface component operable to interface with one or more telephone service carriers, said service carrier in communication with said first user; and
an user account component operable to:
receive a request from said first user to transfer a quantity of value from an account associated with an identifier of said first user, said request including said telephonic identifier associated with said second user;
access said account associated with said identifier of said first user;
determine whether an account is associated with said telephonic identifier of said second user;
process the transfer of value between said account of said first user and said account of said second user if said second user telephonic identifier corresponds to an account.

22. The computer readable medium of claim 21 further comprising a data processing component operable to retrieve payee information based on said telephonic identifier of said second user if said second user telephonic identifier does not correspond to an account.

23. The computer readable medium of claim 21, wherein said user account component is further operable to obtain a request from said first user to fund said first user account with said quantity of value to enable the transfer of said quantity of value.

24. The computer readable medium of claim 21, wherein said quantity of value includes a monetary amount.

25. The computer readable medium of claim 21, wherein said quantity of value includes a line of credit.

26. The computer readable medium of claim 21, wherein said carrier interface component is further operable to notify said second user of the transfer of said quantity of value.

27. The computer readable medium of claim 21, wherein said carrier interface component is further operable to notify said first user of the transfer of said quantity of value.

28. The computer readable medium of claim 21, wherein said telephonic identifier of said second user is a proxy telephonic identifier.

29. The computer readable medium of claim 21, wherein said quantity of value is one of a group consisting essentially of coupons, vouchers, point, rebates, services, monetary funds, credits, and personal goods.

30. The computer readable medium of claim 21, wherein said identifier of said first user is associated with a wireless telephone or a wireline telephone.

31. A system for facilitating the process of a transaction including the transfer of value between a first and a second user, said second user associated with a telephonic identifier, comprising:
a first user desiring to transfer a quantity of value from a first user account;
a second user for receiving said quantity of value, said system establishing an account associated with said telephonic identifier of said second user; and
a transfer server operable to receive a request from said first user desiring to transfer said quantity of value from said first user account, said request including said telephonic identifier of said second user, and further operable to transfer said quantity of value to said account associated with said second user.

32. The system of claim 31, wherein said transfer server is further operable to obtain a request from said first user to fund said first user account with said quantity of value to enable the transfer of said quantity of value.

33. The system of claim 31, wherein said quantity of value includes a monetary amount.

34. The system of claim 31, wherein said quantity of value includes a line of credit.

35. The system of claim 31, wherein if said telephonic identifier associated with said second user does not correspond to an account, said transfer server operable to create an account based on said telephonic identifier associated with said second user.

36. The system of claim 31, wherein said transfer server is further operable to notify said second user of the transfer of said quantity of value.

37. The system of claim 31, wherein said second user is notified of the transfer by said transfer server via a group of notification means associated with said telephonic identifier of said second user consisting essentially of a telephone call notification, a short messaging service notification, an electronic mail notification, and a pager notification.

38. The system of claim 37, wherein said second user is notified by said notification means preselected by said second user.

39. The system of claim 31, wherein said transfer server is further operable to notify said first user of the transfer of said quantity of value.

40. The system of claim 31, wherein said telephonic identifier of said second user is a proxy telephonic identifier.

41. The system of claim 31, wherein said quantity of value is one of a group consisting essentially of coupons, vouchers, point, rebates, services, monetary funds, credits, and personal goods.

42. The system of claim 31, wherein said request includes criteria that must be satisfied prior to the transfer of value.

43. The system of claim 42, wherein said criteria is date specific.

44. The system of claim 42, wherein said criteria is based on an occurrence of an event.

45. The system of claim 31, wherein said first user account corresponds to an identifier, said identifier associated with a wireless telephone or a wireline telephone.

46. The system of claim 31, wherein the transfer between said accounts occurs via a communication to a service provider, said service provider transferring said value between said accounts.

47. The system of claim 31, wherein said telephonic identifier associated with said second user is a proxy identifier, and wherein said transfer server further operable to convert said proxy identifier to said second user account.

48. The system of claim 31, wherein said telephonic identifier associated with said second user is a proxy identifier, said system further comprising a proxy server operable to obtain said second user proxy identifier and associate said proxy identifier with said second user account, wherein said proxy server transmits the identification of said second user account to said transfer server.

49. The system of claim 31, wherein said first user corresponds to a mobile or wireline device.

50. The system of claim 31, wherein said second user corresponds to a mobile or wireline device.
